(19) United States
(12) Patent Application Publication
(10) Pub. No.: US 2023/0419765 A1
(43) Pub. Date: Dec. 28, 2023

(54) MONEY HANDLING METHOD, MONEY HANDLING DEVICE, AND MONEY HANDLING SYSTEM

(71) Applicant: Glory Ltd., Himeji-shi (JP)

(72) Inventor: Tsuyoshi IZUMIDA, Himeji-shi, Hyogo (JP)

(73) Assignee: Glory Ltd., Himeji-shi, Hyogo (JP)

(21) Appl. No.: 18/243,111

(22) Filed: Sep. 7, 2023

Related U.S. Application Data
(63) Continuation of application No. PCT/JP2022/009665, filed on Mar. 7, 2022.

(30) Foreign Application Priority Data
Mar. 11, 2021 (JP) 2021-039613

(51) Int. Cl. G07D 11/245; G07D 11/14; G07D 11/125; G07D 11/34; G07D 11/23

(52) U.S. Cl. CPC G07D 11/245; G07D 11/14; G07D 11/125; G07D 11/34; G07D 11/23; G07D 2211/00

(57) ABSTRACT

In a money handling method, when a predetermined condition is satisfied, a notification is sent that prompts to unload a second money storage from a second handling device and load the second money storage into a first handling device, and the first handling device is caused to transfer money between the second money storage loaded to the first handling device and the first money storage.

### CROSS-REFERENCE TO RELATED APPLICATIONS

This is a continuation of International Application No. PCT/JP2022/009665 filed on Mar. 7, 2022, which claims priority to Japanese Patent Application No. 2021-039613 filed on Mar. 11, 2021. The entire disclosures of these applications are incorporated by reference herein.

### BACKGROUND

The technique disclosed herein relates to money handling methods, money handling devices, and money handling systems.

A conventional change replenishment and collection system replenishes a plurality of change machines with money and collects money from the plurality of change machines using a single cassette. When the cassette is loaded into any of the change machines, the change machine is replenished with money or money is collected from the change machine using the cassette based on excessive-change/short-of-change information held by the change machine. As the cassette is sequentially loaded into the plurality of change machines, transfer of money between or among the plurality of change machines is substantially performed using the cassette.

A conventional automatic teller machine (ATM) management system includes a medium replenishment and collection machine and a central control unit. The medium replenishment and collection machine is self-propelled to move between a plurality of ATMs. The central control unit communicates with each of the ATMs and manages the ATMs. When a failure occurs in any of the ATMs, the central control unit causes the medium replenishment and collection machine to collect media from this ATM and replenish the other ATMs with the collected media.

### SUMMARY

The technique disclosed herein relates to a money handling method that is performed by a first handling device including at least one first money storage and a second handling device including at least one second money storage.

The first handling device may store money deposited from a first inlet in the first money storage. The first handling device may feed out money stored in the first money storage and dispense the money from a first outlet.

The second handling device may store money deposited from a second inlet in the second money storage. The second handling device may feed out money storage in the second money storage and dispense the money from a second outlet.

In this money handling method, in a case where a predetermined condition is satisfied, a notification is sent that prompts to unload the second money storage from the second handling device and load the second money storage into the first handling device.

The first handling device is caused to transfer money between the second money storage loaded to the first handling device and the first money storage.

### BRIEF DESCRIPTION OF THE DRAWINGS

FIG. 1 shows an example of the configuration of a money handling system according to a first embodiment.

FIG. 2 shows an example of the configuration of a money handling system according to a second embodiment.

FIG. 3 shows a modification of the money handling system.

FIG. 4 shows an example of the configuration of a money handling device.

FIG. 5 shows an example of the configuration in which cassettes are loaded to or unloaded from the money handling device.

FIG. 6 shows a process of transferring money from a first handling device to a second handling device when any cassette has become near-full.

FIG. 7 shows a process of transferring money in the money handling system.

FIG. 8 shows a process of transferring money from the first handling device to the second handling device when any cassette has become near-empty.

FIG. 9 shows a process of transferring money between the first handling device and the second handling device when any banknote is rejected.

FIG. 10 shows a process of transferring money in the money handling system when any banknote is rejected.

FIG. 11 shows a modification of the process of transferring money between the first handling device and the second handling device when any banknote is rejected.

### DETAILED DESCRIPTION

The conventional systems can transfer money between or among a plurality of handling devices by using a dedicated device (i.e., cassette). However, the conventional systems cannot transfer money between or among the plurality of handling devices in a simple manner.

The technique disclosed herein implements transfer of money between or among a plurality of handling devices in a simple manner.

The technique disclosed herein relates to a money handling method that is performed by a first handling device including at least one first money storage unit and a second handling device including at least one second money storage unit.

The first handling device may store money deposited from a first inlet in the first money storage unit. The first inlet and the first money storage unit are connected by a transport unit. The first handling device may feed out money stored in the first money storage unit and dispense the money from a first outlet. The first outlet and the first money storage unit are connected by the transport unit.

The second handling device may store money deposited from a second inlet in the second money storage unit. The second inlet and the second money storage unit are connected by a transport unit. The second handling device may feed out money storage in the second money storage unit and dispense the money from a second outlet. The second outlet and the second money storage unit are connected by the transport unit.

In this money handling method, in a case where a predetermined condition is satisfied, a notification is sent that prompts to unload the second money storage unit from the second handling device and load the second money storage unit into the first handling device. An entity that sends the notification may be either a notification unit provided in the first handling device or a notification unit provided in the second handling device, or may be both of the notification units. The entity that sends the notification may be a notification unit different from the first handling device and the second handling device.

The first handling device is caused to transfer money between the second money storage unit loaded to the first handling device and the first money storage unit. The second money storage unit loaded to the first handling device and the first money storage unit are connected by the transport unit.

Whether the predetermined condition is satisfied may be determined by a controller of the first handling device or a controller of the second handling device. Alternatively, in a case where the predetermined condition is satisfied may be determined by a management device to which the first handling device and the second handling device are connected. The controller of the first handling device may control the transport unit and the notification unit of the first handling device, and the controller of the second handling device may control the transport unit and the notification unit of the second handling device.

The second money storage unit may be provided with a memory unit that stores identification information of the second money storage unit, and the identification information of the second money storage unit loaded to the first handling device may be checked.

According to this money handling method, transfer of money between or among the plurality of handling devices is implemented in a simple manner.

The predetermined condition may include that an inventory amount of the first money storage unit is smaller than a first criterion or is larger than a second criterion.

In a case where the first money storage unit is near-empty, the first money storage unit can be replenished with money. Alternatively, in a case where the first money storage unit is near-full, money can be collected from the first money storage unit.

Whether there is the second money storage unit that is able to transfer money to or from the first money storage unit may be checked in a case where the inventory amount of the first money storage unit is smaller than the first criterion or larger than the second criterion.

In a case where there is the second money storage unit that is able to transfer money, replenishment of the first money storage unit with money or collection of money from the first money storage unit can be implemented.

The predetermined condition may include that an inventory amount of the second money storage unit is smaller than a first criterion or is larger than a second criterion.

In a case where the second money storage unit is near-empty, the second money storage unit can be replenished with money. Alternatively, in a case where the second money storage unit is near-full, money can be collected from the second money storage unit.

Whether there is the first money storage unit that is able to transfer money to or from the second money storage unit may be checked in a case where the inventory amount of the second money storage unit is smaller than the first criterion or larger than the second criterion.

In a case where there is the first money storage unit that is able to transfer money, replenishment of the second money storage unit with money or collection of money from the second money storage unit can be implemented.

The second money storage unit “being able to transfer money to and from the first money storage unit” means that (1) the second money storage unit stores money of the same type as the money stored in the first money storage unit, or money that can substitute for the money stored in the first money storage unit, and (2) the second money storage unit stores money enough to replenish the first money storage unit, or has a space enough to collect money from the first money storage unit. The first money storage unit “being able to transfer money to and from the second money storage unit” means that (1) the first money storage unit stores money of the same type as the money stored in the second money storage unit, or money that can substitute for the money stored in the second money storage unit, and (2) the first money storage unit stores money enough to replenish the second money storage unit, or has a space enough to collect money from the second money storage unit.

The inventory amount of the first money storage unit may be updated after money is transferred between the second money storage unit and the first money storage unit.

An accurate inventory amount of the first money storage unit after transfer of money is thus held.

The first handling device may be caused to output information on transfer of money between the second money storage unit and the first money storage unit. After the transfer of money between the second money storage unit and the first money storage unit is completed, a notification may be sent that prompts to load the second money storage unit unloaded from the first handling device back into the second handling device. The inventory amount of the second money storage unit may be updated based on the information.

An accurate inventory amount of the second money storage unit after transfer of money is thus held.

In a case where any money is rejected while money is being transferred between the second money storage unit loaded to the first handling device and the first money storage unit, the second handling device may be caused to perform a reconciliation process after the second money storage unit is loaded into the second handling device, the reconciliation process being a process of confirming the inventory amount of the second money storage unit.

The inventory amount of the second money storage unit is confirmed by performing the reconciliation process.

In a case where any money is rejected while money is being transferred between the second money storage unit loaded to the first handling device and the first money storage unit, the rejected money may be stored in a first reject storage unit of the first handling device.

The rejected money is thus properly managed in the first handling device.

After the money is rejected, a sum of an inventory amount of the first reject storage unit of the first handling device and an inventory amount of a second reject storage unit of the second handling device may be held as an inventory amount.

The inventory amount of the first handling device and the inventory amount of the second handling device are thus held accurately.

In a case where any money is rejected while money is being transferred between the second money storage unit loaded to the first handling device and the first money storage unit, the first handling device may store the rejected money in a temporary storage unit. After transfer of money between the second money storage unit and the first money storage unit is completed, the first handling device may transfer the rejected money in the temporary storage unit to a second reject storage unit of the second handling device that has been loaded to the first handling device.

The rejected money is thus returned to the second handling device.

The technique disclosed herein also relates to a money handling device. The money handling device includes: at least one first money storage unit configured to store money deposited from an inlet and feed out stored money to be dispensed from an outlet; a plurality of loading portions to which the first money storage unit is detachably loaded; and a control unit configured to perform a process related to money using the first money storage unit. In a case where a predetermined condition is satisfied, the control unit performs transfer of money between a second money storage unit unloaded from a second money handling device based on the predetermined condition and loaded to the loading portion and the first money storage unit.

This money handling device can implement transfer of money between or among the plurality of money handling devices in a simple manner.

The first money storage unit may be detachably loaded to each of the plurality of loading portions, and the control unit may allow the second money storage unit to be loaded to any one of the plurality of loading portions.

This money handling device can implement transfer of money between or among the plurality of money handling devices in a simpler manner.

The control unit may allow the second money storage unit to be unloaded from the first handling device in order to load the second money storage unit back into the second money handling device after the transfer of money between the second money storage unit and the first money storage unit is completed.

This money handling device and the second money handling device can perform money handling independently of each other after money is transferred between the plurality of money handling devices.

The technique disclosed herein also relates to a money handling system. The money handling system is a system that performs any of the above methods. For example, the money handling system includes: a first handling device including at least one first money storage unit configured to store money deposited from a first inlet and feed out stored money to be dispensed from a first outlet; and a second handling device including at least one second money storage unit configured to store money deposited from a second inlet and feed out stored money to be dispensed from a second outlet. In a case where a predetermined condition is satisfied, a notification is sent that prompts to unload the second money storage unit from the second handling device and load the second money storage unit into the first handling device. The first handling device is caused to transfer money between the second money storage unit loaded to the first handling device and the first money storage unit.

This money handling system implements transfer of money between or among the plurality of handling devices in a simple manner.

The money handling system may further include a management device connected to each of the first handling device and the second handling device. The management device may check whether the second money storage unit that is able to transfer money to or from the first money storage unit is present in the second handling device.

The management device can manage transfer of money between or among the plurality of handling devices.

Embodiments of a money handling method, a money handling device, and a money handling system will be described below with reference to the drawings. The money handling method, the money handling device, and the money handling system described herein are illustrated by way of example.

### First Embodiment

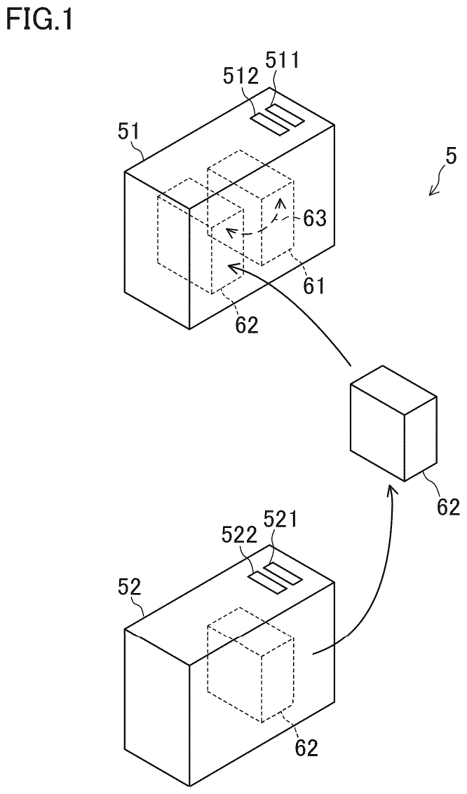

FIG. 1 shows an example of the configuration of a money handling system 5. The money handling system 5 includes a first handling device 51 and a second handling device 52.

The first handling device 51 performs a process related to money. The first handling device 51 has a first inlet 511 and a first outlet 512. The first inlet 511 receives money to be deposited. The first outlet 512 dispenses money to be withdrawn. The first handling device 51 may have an integrated slot of an inlet and an outlet.

The first handling device 51 includes a first money storage unit 61. In the example of FIG. 1, the first money storage unit 61 is disposed inside the first handling device 51. The first money storage unit 61 stores money received from the first inlet 511 and feeds out stored money. The money fed out of the first money storage unit 61 is dispensed from the first outlet 512. The first money storage unit 61 is a so-called recycle storage unit. The first handling device 51 holds the inventory amount of the first money storage unit 61.

In the example of FIG. 1, the first handling device 51 includes one first money storage unit 61. However, the first handling device 51 may include a plurality of first money storage units 61.

Like the first handling device 51, the second handling device 52 also performs a process related to money. The second handling device 52 has a second inlet 521 and a second outlet 522. The second handling device 52 may also have an integrated slot of an inlet and an outlet.

The second handling device 52 includes a second money storage unit 62. In the example of FIG. 1, the second money storage unit 62 is disposed inside the second handling device 52. The second money storage unit 62 stores money received from the second inlet 521 and feeds out stored money. The money fed out of the second money storage unit 62 is dispensed from the second outlet 522. The second money storage unit 62 is a so-called recycle storage unit. The second handling device 52 holds the inventory amount of the second money storage unit 62. The second handling device 52 may also include a plurality of second money storage units 62.

The second money storage unit 62 can be unloaded from the second handling device 52. The second money storage unit 62 unloaded from the second handling device 52 can be loaded into the first handling device 51.

The first handling device 51 the second money storage unit 62 loaded therein can transfer money between the second money storage unit 62 and the first money storage unit 61 (see dashed arrow 63 in FIG. 1).

Next, how money is transferred in the money handling system 5 will be described. When a predetermined condition is satisfied in the money handling system 5, the money handling system 5 switches from a normal mode to a money transfer mode. The normal mode is a mode in which each of the first handling device 51 and the second handling device 52 independently performs money handling. The money transfer mode is a mode in which the first handling device 51 and the second handling device 52 cooperate to transfer money.

When the predetermined condition is satisfied in the money handling system 5, a notification is sent to an operator. The notification is a notification prompting the operator to unload the second money storage unit 62 from the second handling device 52 and load the second money storage unit 62 into the first handling device 51. The notification is not limited to this as long as the money storage unit to be moved and the handling device to which the money storage unit is moved can be identified. For example, the notification may be a notification that second money storage unit 62 satisfies a predetermined condition described later and that the first handling device 51 can transfer money with the second money storage unit 62. The first handling device 51 may send the notification, or the second handling device 52 may send the notification. A management device for the money handling system 5 may send the notification, or a terminal may send the notification. Alternatively, a mobile terminal carried by the operator may send the notification.

For example, the predetermined condition is that the inventory amount of the first money storage unit 61 is smaller than a first criterion. In this case, since the first money storage unit 61 stores only a small amount of money, the first handling device 51 will no longer be able to perform money handling, particularly a withdrawal process of feeding out money from the first money storage unit 61.

Another example of the predetermined condition is that the inventory amount of the first money storage unit 61 is larger than a second criterion. In this case, since the first money storage unit 61 stores a large amount of money, the first handling device 51 will no longer be able to perform money handling, particularly a deposit process of storing money in the first money storage unit 61.

In response to the notification, the operator unloads the second money storage unit 62 from the second handling device 52 and loads the second money storage unit 62 into the first handling device 51.

After the second money storage unit 62 is loaded into the first handling device 51, the first handling device 51 transfers money between the second money storage unit 62 and the first money storage unit 61. When the inventory amount of the first money storage unit 61 is less than the first criterion, the first handling device 51 transfers money from the second money storage unit 62 to the first money storage unit 61. The amount of money stored in the first money storage unit 61 therefore increases. It is herein assumed that the second money storage unit 62 loaded in the first handling device 51 stores a sufficient amount of money.

When the inventory amount of the first money storage unit 61 is larger than the second criterion, the first handling device 51 transfers money from the first money storage unit 61 to the second money storage unit 62. The amount of money stored in the first money storage unit 61 therefore decreases. It is herein assumed that the second money storage unit 62 loaded in the first handling device 51 has enough space available.

Since money is transferred between the first money storage unit 61 and the second money storage unit 62, the first handling device 51 can continue to perform money handling. After money is transferred, the first handling device 51 updates the inventory amount of the first money storage unit 61 based on the transferred amount of money.

In this money handling system 5, the recycle storage unit (i.e., the second money storage unit 62) of the second handling device 52 can be unloaded from the second handling device 52 and loaded into the first handling device 51, and the first handling device 51 can transfer money between the second money storage unit 62 and the first money storage unit 61. The money handling system 5 can thus implement transfer of money between or among a plurality of handling devices in a simple manner.

After the first handling device 51 transfers money between the second money storage unit 62 and the first money storage unit 61, the operator unloads the second money storage unit 62 from the first handling device 51 and loads the second money storage unit 62 back into the second handling device 52. The second handling device 52 can thus also continue to perform money handling. After the second money storage unit 62 is loaded into the second handling device 52, the second handling device 52 updates the inventory amount of the second money storage unit 62. For example, the first handling device 51 may provide information on the transferred amount of money may to the second handling device 52.

The operator may unload the first money storage unit 61 from the first handling device 51 and load the first money storage unit 61 into the second handling device 52 instead of unloading the second money storage unit 62 from the second handling device 52 and loading the second money storage unit 62 into the first handling device 51. In this case, the second handling device 52 transfers money between the first money storage unit 61 and the second money storage unit 62.

### Second Embodiment

Overall Configuration of Money Handling System

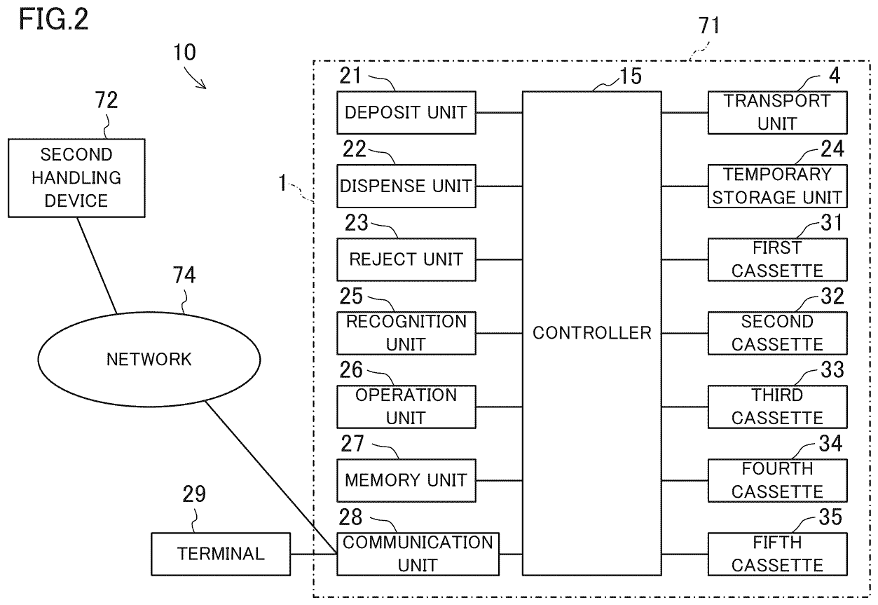

FIG. 2 illustrates a money handling system 10 according to a second embodiment. The money handling system 10 is a modification of the money handling system 5 of FIG. 1.

The money handling system 10 is built in, for example, a branch of a financial institution. The financial institution is, for example, a bank. However, the money handling system 10 is not limited to being built in a branch of a financial institution.

The money handling system 10 includes a first handling device 71 and a second handling device 72. The first handling device 71 and the second handling device 72 are installed in the same branch of the financial institution. The first handling device 71 and the second handling device 72 can communicate with each other via a network 74.

Each of the first handling device 71 and the second handling device 72 performs money handling. The configurations of the first handling device 71 and the second handling device 72 will be described later.

The network 74 is a wide area network (WAN) and/or a local area network (LAN). The WAN is, for example, the Internet. The LAN is, for example, a LAN built in a financial institution and/or a LAN built in a store.

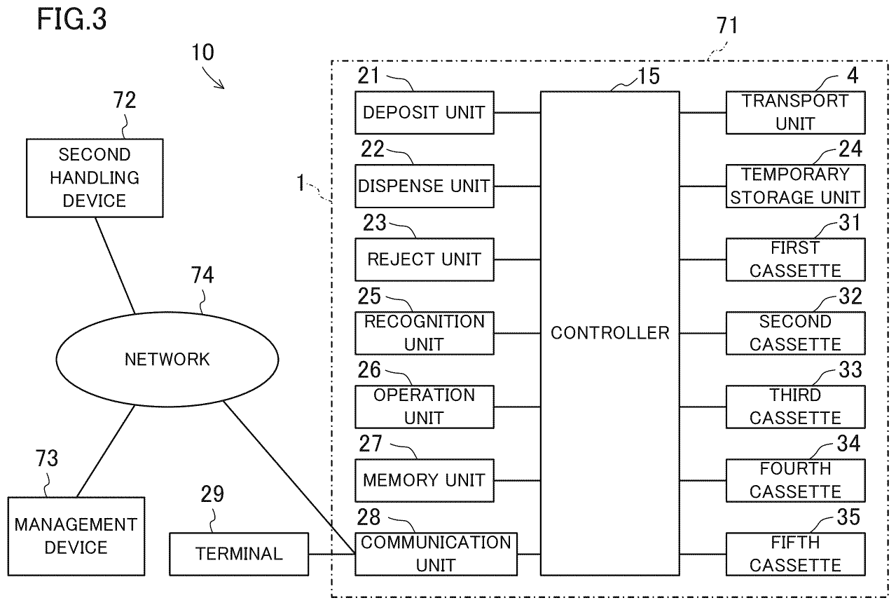

FIG. 3 shows a modification of the money handling system. A money handling system 100 includes the first handling device 71, the second handling device 72, and a management device 73. The management device 73 manages the money handling system 100. The first handling device 71 and the second handling device 72 are installed in the same branch of the financial institution. The management device 73 may be installed in the branch where the first handling device 71 and the second handling device 72 are installed or may be installed in a place different from the branch. The management device 73 can communicate with the first handling device 71 and the second handling device 72 via the network 74.

The management device 73 is, for example, a general-purpose computer. The management device 73 includes at least a processor, a memory, and an interface (I/F) circuit. The processor executes a program. The memory stores programs and data for operation of the management device 73. The memory is, for example, a random access memory (RAM) and/or a read-only memory (ROM). The I/F circuit transfers electrical signals between the management device 73 and each device connected to the management device 73.

Configuration of Handling Device

The first handling device 71 and the second handling device 72 have the same configuration. FIGS. 2 to 5 illustrate the configuration of a handling device 1. The first handling device 71 and the second handling device 72 are collectively referred to as “handling device 1.” The handling device 1 is a modification of the first handling device 51 and the second handling device 52 in FIG. 1.

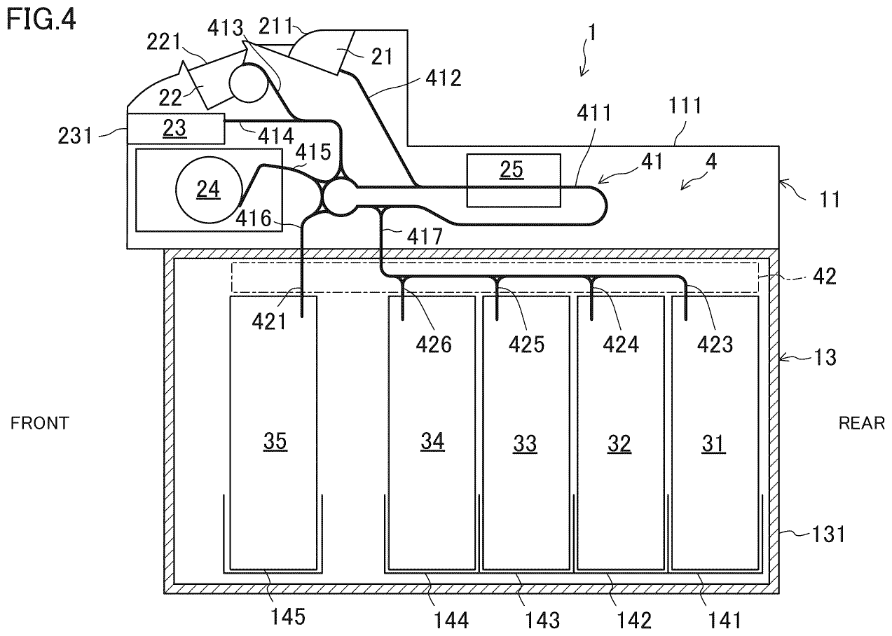

FIG. 2 or 3 is a block diagram of the handling device 1. FIG. 4 conceptually illustrates the structure inside the handling device 1. The handling device 1 has a shape elongated in the front-rear direction. The front of the handling device 1 refers to a portion where an inlet 211 and an outlet 221, which will be described later, are located. The rear of the handling device 1 refers to the opposite portion of the handling device 1 from the portion where the inlet 211 and the outlet 221 are located.

The handling device 1 handles loose notes. The handling device 1 serves as a money handling device and a banknote handling device. The handling device 1 includes a handling unit 11 located in its upper portion and a lower safe unit 13 located in its lower portion. The handling unit 11 is composed of an upper housing 111. A deposit unit 21, a dispense unit 22, a reject unit 23, a temporary storage unit 24, a recognition unit 25, and an upper transport unit 41 are disposed in the upper housing 111. The upper transport unit 41 is part of a transport unit 4.

The safe unit 13 is composed of a safe housing 131. A plurality of cassettes 31 to 35 and a lower transport unit 42 are disposed in the safe housing 131. The lower transport unit 42 is part of the transport unit 4.

Each of the cassettes 31 to 35 forms a money storage unit for storing banknotes. The safe housing 131 protects the cassettes 31 to 35 at a predetermined security level or higher. Specifically, the safe housing 131 is made of a metal plate having a predetermined thickness or more. The security level of the safe housing 131 is higher than that of the upper housing 111.

The deposit unit 21 is a portion into which banknotes to be deposited are placed in, for example, a deposit process. The deposit unit 21 has the inlet 211. The inlet 211 is open upward in the front part of the upper housing 111. The operator places banknotes into the deposit unit 21 by hand through the inlet 211. The deposit unit 21 can hold a plurality of banknotes in a stack. The deposit unit 21 has a mechanism for taking banknotes one by one into the handling device 1.

The dispense unit 22 is a portion to which banknotes fed out of the cassettes 31 to 35 are transferred in, for example, a withdrawal process. The dispense unit 22 can hold a plurality of banknotes in a stack. The dispense unit 22 has the outlet 221. The outlet 221 is open upward at a position forward of the inlet 211. The operator can take out banknotes accumulated in the dispense unit 22 by hand through the outlet 221. The outlet 221 may be provided with a shutter that opens and closes. Banknotes rejected in a deposit process may be transported to the dispense unit 22.

The reject unit 23 is disposed in the front part of the upper housing 111. The reject unit 23 is configured to hold a plurality of banknotes in a stack. The reject unit 23 has a reject outlet 231. The reject outlet 231 is open in the front part of the upper housing 111. The reject outlet 231 is provided with a shutter. When the shutter opens, the operator can take out banknotes accumulated in the reject unit 23 through the reject outlet 231. Banknotes rejected in, for example, a deposit process may be transported to the reject unit 23.

The temporary storage unit 24 temporarily stores banknotes to be deposited in, for example, a deposit process. As will be described later, the temporary storage unit 24 may be used in other applications. The temporary storage unit 24 can feed out stored banknotes. The temporary storage unit 24 is disposed at a front position in the upper housing 111. The temporary storage unit 24 is a tape type storage unit. The temporary storage unit 24 stores banknotes by winding the banknotes together with a tape around a drum. The tape type storage unit is advantageous in that the order of banknotes does not change when the banknotes are stored and when the banknotes are fed out. The tape type storage unit is also advantageous in that it can store a mixture of banknotes of various sizes. A known configuration of a tape type storage unit can be used for the temporary storage unit 24.

The recognition unit 25 is disposed in a first transport path 411. The recognition unit 25 recognizes at least the authenticity, denomination, and fitness of each of banknotes transported along the first transport path 411. The recognition unit 25 also acquires the identification numbers of banknotes. The identification number is a unique code that identifies a banknote. The identification number of a banknote is also called to as “serial number.”

The identification numbers of banknotes acquired by the recognition unit 25 are stored in a memory unit 27 (see FIG. 2 or 3). The memory unit 27 stores information on banknotes stored in each of the first cassette 31, the second cassette 32, the third cassette 33, the fourth cassette 34, and the fifth cassette 35 that will be described later. Specifically, the memory unit 27 stores the number of banknotes stored in each storage unit, their denominations, and the total amount of money stored in each storage unit. The memory unit 27 also stores the identification numbers of the individual banknotes stored in each cassette 31 to 35. The memory unit 27 stores the identification numbers in the order in which the banknotes are stored. Information associating the order in which the banknotes are stored with the identification numbers is hereinafter sometimes referred to as “identification number list.”

The handling device 1 includes the first cassette 31, the second cassette 32, the third cassette 33, the fourth cassette 34, and the fifth cassette 35.

The safe unit 13 includes a first loading portion 141, a second loading portion 142, a third loading portion 143, a fourth loading portion 144, and a fifth loading portion 145. Each cassette is detachably loaded to a corresponding one of the loading portions. Specifically, the first cassette 31 is detachably loaded to the first loading portion 141, the second cassette 32 is detachably loaded to the second loading portion 142, the third cassette 33 is detachably loaded to the third loading portion 143, the fourth cassette 34 is detachably loaded to the fourth loading portion 144, and the fifth cassette 35 is detachably loaded to the fifth loading portion 145. The first cassette 31, the second cassette 32, the third cassette 33, the fourth cassette 34, and the fifth cassette 35 are located next to each other in the front-rear direction in the safe housing 131.

The first cassette 31, the second cassette 32, the third cassette 33, the fourth cassette 34, and the fifth cassette 35 all have the same shape and the same structure. Therefore, each of the first cassette 31, the second cassette 32, the third cassette 33, the fourth cassette 34, and the fifth cassette 35 can be detachably loaded to any of the first loading portion 141, the second loading portion 142, the third loading portion 143, the fourth loading portion 144, and the fifth loading portion 145.

Each of the first cassette 31, the second cassette 32, the third cassette 33, the fourth cassette 34, and the fifth cassette 35 has a memory unit having identification information stored therein. When a cassette is loaded to a loading portion, the handling device 1 reads the identification information from the memory unit of the cassette and identifies the loaded cassette. The handling device 1 notifies the operator when the cassette is loaded to a wrong loading portion.

Each of the first cassette 31, the second cassette 32, the third cassette 33, the fourth cassette 34, and the fifth cassette 35 forms a money storage unit of the handling device 1. When the handling device 1 is the first handling device 71, each of the first cassette 31, the second cassette 32, the third cassette 33, the fourth cassette 34, and the fifth cassette 35 is a first money storage unit. When the handling device 1 is the second handling device 72, each of the first cassette 31, the second cassette 32, the third cassette 33, the fourth cassette 34, and the fifth cassette 35 is a second money storage unit.

Each of the first cassette 31, the second cassette 32, the third cassette 33, the fourth cassette 34, and the fifth cassette 35 of the first handling device 71 can be loaded to any of the first loading portion 141, the second loading portion 142, the third loading portion 143, the fourth loading portion 144, and the fifth loading portion 145 of the second handling device 72. Each of the first cassette 31, the second cassette 32, the third cassette 33, the fourth cassette 34, and the fifth cassette 35 of the second handling device 72 can be loaded to any of the first loading portion 141, the second loading portion 142, the third loading portion 143, the fourth loading portion 144, and the fifth loading portion 145 of the first handling device 71.

Each of the cassettes 31 to 35 is a stack type storage device. The stack type storage device store banknotes in a stack. Each of the cassettes 31 to 35 has a transport mechanism. The transport mechanism loads banknotes from outside into the cassette 31 to 35 and stores the banknotes in the cassette 31 to 35. The transport mechanism also unloads banknotes stored in the cassette 31 to 35 out of the cassette 31 to 35.

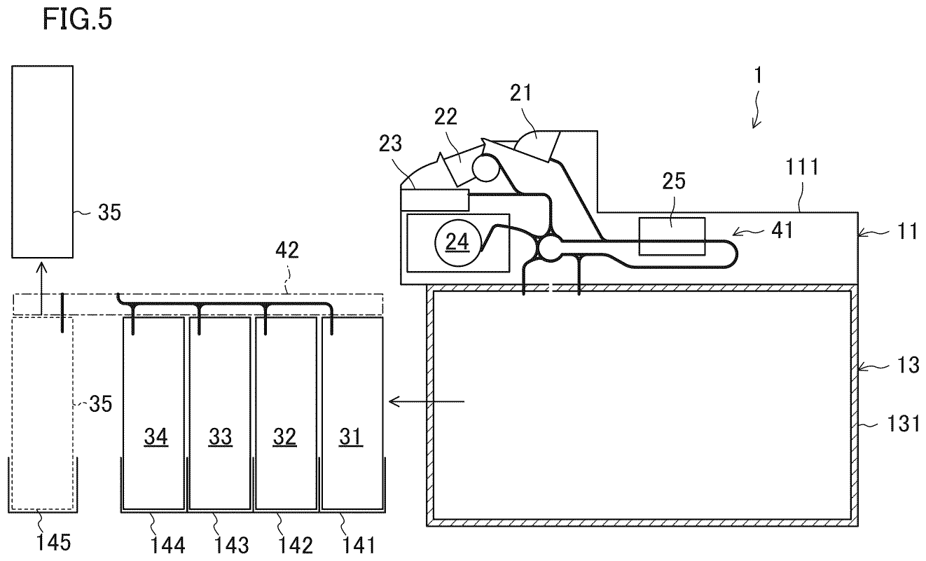

Each cassette is in the shape of a box. Each cassette can be unloaded from the loading portion with banknotes stored in the cassette and can be loaded to the loading portion with banknotes stored in the cassette. Specifically, as illustrated in FIG. 5, the operator can open a front door of the safe housing 131 and pull the cassettes 31 to 35 out of the safe housing 131. After pulling the cassettes 31 to 35 out of the safe housing 131, the operator individually pulls the first cassette 31, the second cassette 32, the third cassette 33, the fourth cassette 34, and the fifth cassette 35 upward. The operator can thus unload the first cassette 31, the second cassette 32, the third cassette 33, the fourth cassette 34, and the fifth cassette 35 from the first loading portion 141, the second loading portion 142, the third loading portion 143, the fourth loading portion 144, and the fifth loading portion 145.

The cassettes 31 to 35 unloaded from the loading portions 141 to 145 are locked. Therefore, the operator cannot touch banknotes in the cassettes 31 to 35.

The configuration of the cassettes in FIG. 4 is shown by way of example, and the number and arrangement of cassettes housed in the safe housing 131 and the structure of each cassette are not limited to the configuration of FIG. 4.

The transport unit 4 transports banknotes one by one inside the handling device 1 with a space between the banknotes. The transport unit 4 has a transport path. The transport path is composed of a combination of a large number of rollers, a plurality of belts, a motor for driving the rollers and the belts, and a plurality of guides. The transport unit 4 transports banknotes with their long edges facing forward. The transport unit 4 may transport banknotes with their short edges facing forward.

The transport unit 4 includes an upper transport unit 41 and a lower transport unit 42. As described above, the upper transport unit 41 is disposed inside the upper housing 111. The lower transport unit 42 is disposed inside the safe housing 131. The upper transport unit 41 and the lower transport unit 42 are connected to each other via a transport path provided in an upper wall forming the safe housing 131.

The upper transport unit 41 has a first transport path 411 in the shape of a loop. The recognition unit 25 is disposed at an intermediate position in the first transport path 411. The transport unit 4 transports banknotes along the first transport path 411 in the clockwise and counterclockwise directions in FIG. 4.

The deposit unit 21, the dispense unit 22, the reject unit 23, and the temporary storage unit 24 are connected to the first transport path 411 via a second transport path 412, a third transport path 413, a fourth transport passage 414, and a fifth transport path 415, respectively.

The lower transport unit 42 is disposed above of the first to fifth cassettes 31 to 35. The lower transport unit 42 has an eighth transport path 421 and a ninth transport path 423.

The eighth transport path 421 connects the fifth cassette 35 and a sixth transport path 416 of the upper transport unit 41 to each other. The sixth transport path 416 is connected to the first transport path 411.

The ninth transport path 423 connects each of the first cassette 31, the second cassette 32, the third cassette 33, and the fourth cassette 34 to a seventh transport path 417 of the upper transport unit 41. The seventh transport path 417 is connected to the first transport path 411.

The ninth transport path 423 extends in the front-rear direction. An end of the ninth transport path 423 is connected to the first cassette 31. The ninth transport path 423 includes three diverging paths, namely first to third three diverging paths 424, 425, and 426. The first diverging path 424 is connected to the second cassette 32. The second diverging path 425 is connected to the third cassette 33. The third diverging path 426 is connected to the fourth cassette 34.

A diverting mechanism and a passage sensor are disposed in each of the first to ninth transport paths 411 to 417, 421, and 423 to 426. The diverting mechanism diverts banknotes. The passage sensor detects passage of banknotes. In response to a command from a controller that will be described later, the transport unit 4 controls each diverting mechanism based on a detection signal from the passage sensor to transport each banknote to a predetermined transport destination.

As shown in FIG. 2 or 3, the handling device 1 includes the controller 15. The controller 15 is a control circuitry that includes at least a processor and an I/F circuit. The processor executes a program. The controller 15 may include a memory different from the memory unit 27. The memory stores programs and data for operation of the processor. The memory is, for example, RAM and/or ROM. The I/F circuit transfers electrical signals between the controller 15 and each device connected to the controller 15.

The deposit unit 21, the dispense unit 22, the reject unit 23, the temporary storage unit 24, the recognition unit 25, the transport unit 4, the first cassette 31, the second cassette 32, the third cassette 33, the fourth cassette 34, and the fifth cassette 35 are connected to the controller 15 so that they can send and receive signals to and from the controller 15.

The handling device 1 includes an operation unit 26 that is operated by the operator, the memory unit 27 that stores various types of data etc., and a communication unit 28 for communicating with a terminal 29. The operation unit 26, the memory unit 27, and the communication unit 28 are also connected to the controller 15 so that they can send and receive signals to and from the controller 15. The operation unit 26 may be, for example, a touch panel display device. The terminal 29 is operated by an operator to perform various processes using the handling device 1. The communication unit 28 communicates also with other handling devices and/or the management device 73 via the network 74.

The controller 15 controls the deposit unit 21, the dispense unit 22, the reject unit 23, the temporary storage unit 24, the recognition unit 25, the transport unit 4, the first cassette 31, the second cassette 32, the third cassette 33, the fourth cassette 34, and the fifth cassette 35 so that various processes are performed when the operator operates the operation unit 26 or when the operator operates the terminal 29. The operation when the handling device 1 performs various processes will be described below.

It is herein assumed that the first cassette 31, the second cassette 32, the third cassette 33, the fourth cassette 34, and the fifth cassette 35 of the handling device 1 store different banknotes. For example, the first cassette 31 stores one-dollar banknotes, the second cassette 32 stores ten-dollar banknotes, the third cassette 33 stores fifty-dollar banknotes, and the fourth cassette 34 stores one-hundred-dollar banknotes. In this case, the first to fourth cassettes 31 to 34 are so-called recycle cassettes. The fifth cassette 35 stores banknotes rejected in a withdrawal process. The fifth cassette 35 may store banknotes that are not stored in the first to fourth cassettes 31 to 34, in addition to storing rejected banknotes.

Deposit Process in Handling Device

The handling device 1 stores banknotes in the cassettes 31 to 34 in a deposit process. The operator places banknotes to be deposited into the deposit unit 21. The deposit unit 21 takes the banknotes one by one into the device. The transport unit 4 transports the banknotes to the recognition unit 25. The recognition unit 25 recognizes the banknotes. The transport unit 4 transports each of the banknotes to the first cassette 31, the second cassette 32, the third cassette 33, or the fourth cassette 34 according to the recognition results from the recognition unit 25. The cassettes 31 to 34 store the banknotes. The transport unit 4 transports any banknote recognized as a rejected note by the recognition unit 25 to the dispense unit 22 or the reject unit 23.

When all the banknotes placed into the deposit unit 21 are taken into the handling device 1, the terminal 29, for example, displays the deposited amount. The deposit process ends when the operator confirms the deposit process by operating the terminal 29 or by operating the operation unit 26. The controller 15 causes the memory unit 27 to store data on the banknotes stored in the cassettes 31 to 34. The memory unit 27 stores the updated inventory amounts of the cassettes 31 to 34. The memory unit 27 also updates and stores the identification number lists of the cassettes 31 to 34.

When the temporary storage unit 24 is used in the deposit process, the transport unit 4 transports banknotes having passed through the recognition unit 25 to the temporary storage unit 24. The temporary storage unit 24 stores the banknotes. After all the banknotes placed into the deposit unit 21 are taken into the handling device 1, the terminal 29, for example, displays the deposited amount. The operator can select to either confirm or cancel the deposit process by operating the terminal 29 or by operating the operation unit 26. When the operator confirms the deposit process, the transport unit 4 transports each of the banknotes fed out of the temporary storage unit 24 to the first cassette 31, the second cassette 32, the third cassette 33, or the fourth cassette 34. The cassettes 31 to 34 store the banknotes. When the operator cancels the deposit process, the transport unit 4 transports the banknotes fed out of the temporary storage unit 24 to the dispense unit 22. The banknotes to be deposited are thus returned.

Withdrawal Process in Handling Device

The handling device 1 dispenses banknotes out of the handling device 1 in a withdrawal process. The cassettes 31 to 34 feed out banknotes to be dispensed. The transport unit 4 transports the banknotes to the recognition unit 25. The recognition unit 25 recognizes the banknotes. The transport unit 4 transports each of the recognized banknotes to the dispense unit 22. The dispense unit 22 holds the banknotes to be dispensed. The transport unit 4 transports any banknote recognized as a rejected banknote by the recognition unit 25 to the fifth cassette 35. The fifth cassette 35 stores any rejected banknotes. The withdrawal process ends when all the banknotes to be dispensed are dispensed to the dispense unit 22. The controller 15 erases data on the banknotes fed out of the cassettes 31 to 34 from the memory unit 27. The memory unit 27 stores the updated inventory amounts of the cassettes 31 to 34. The memory unit 27 also updates and stores the identification number lists of the cassettes 31 to 34.

The handling device 1 may perform the following operation instead of transporting any banknote recognized as a rejected banknote by the recognition unit 25 to the fifth cassette 35. The transport unit 4 may transport any banknote recognized as a rejected banknote by the recognition unit 25 to the temporary storage unit 24. The temporary storage unit 24 may temporarily store this banknote. After the withdrawal process ends, the temporary storage unit 24 may feed out the temporarily stored banknotes, and the recognition unit 25 may recognize each of them and store them in the cassettes 31 to 34 according to the recognition results. Any banknote recognized again as a rejected banknote by the recognition part 25 may be stored in the fifth cassette 35.

Process of Transferring Money Between Plurality of Handling Devices

The first handling device 71 and the second handling device 72 perform the deposit process and/or the withdrawal process independently of each other. As the deposit process and/or the withdrawal process is repeated, the inventory amount of any of the cassettes 31 to of the first handling device 71 or the second handling device 72 may become smaller than the first criterion. Namely, any of the cassettes 31 to 35 may become near-empty. Alternatively, as the deposit process and/or the withdrawal process is repeated, the inventory amount of any of the cassettes 31 to 35 of the first handling device 71 or the second handling device 72 may become larger than the second criterion. Namely, any of the cassettes 31 to 35 may become near-full.

When any of the cassettes 31 to 35 has become near-empty or near-full, it is difficult for the handling device 71 or 72 to continue the process. The operator needs to collect money from the cassettes 31 to 35 or replenish the cassettes 31 to 35 with money.

However, when the operator tries to collect money from the cassettes 31 to 35 or replenish the cassettes 31 to 35 with money, the operator needs to handle the money directly by hand. Only an operator with special authority can handle money directly by hand. Therefore, it may not be possible to collect money from the cassettes 31 to 35 or replenish the cassettes 31 to 35 with money at a desired timing during business hours of the branch of the financial institution.

In view of the business efficiency at the branch of the financial institution, it is desired that money can be collected from the cassettes 31 to 35 and/or the cassettes 31 to 35 can be replenished with money without the need for the operator to handle the money directly by hand.

The money handling system 10 or 100 may collect money from the cassettes 31 to 35 and/or replenish the cassettes 31 to 35 with money without the need for the operator to handle the money directly by hand. Specifically, the money handling system 10 or 100 can switch the cassettes 31 to 35 between the plurality of handling devices 71, 72 and transfer money between the switched cassettes 31 to 35. The operator merely switches the cassettes 31 to 35 and does not handle the money directly by hand. The operator therefore is not required to have special authority.

Money Transfer Process when any Cassette has Becomes Near-Full

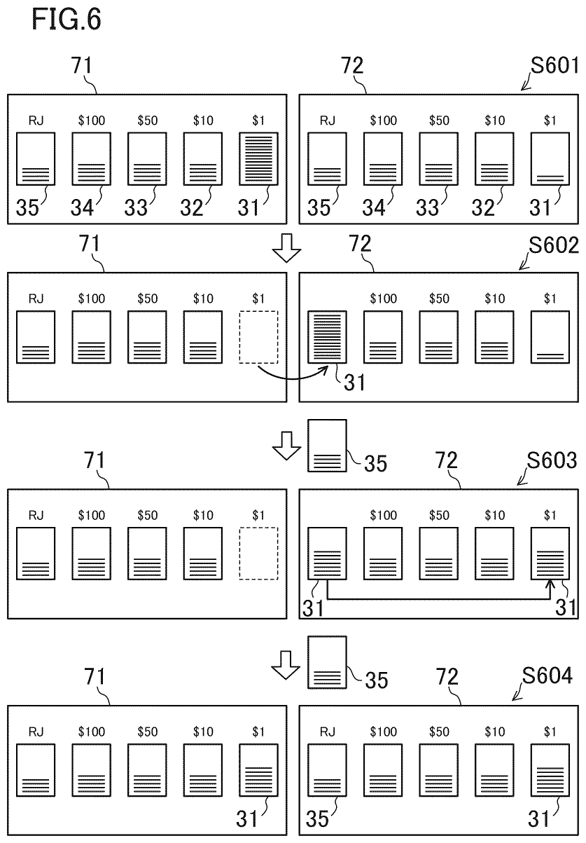

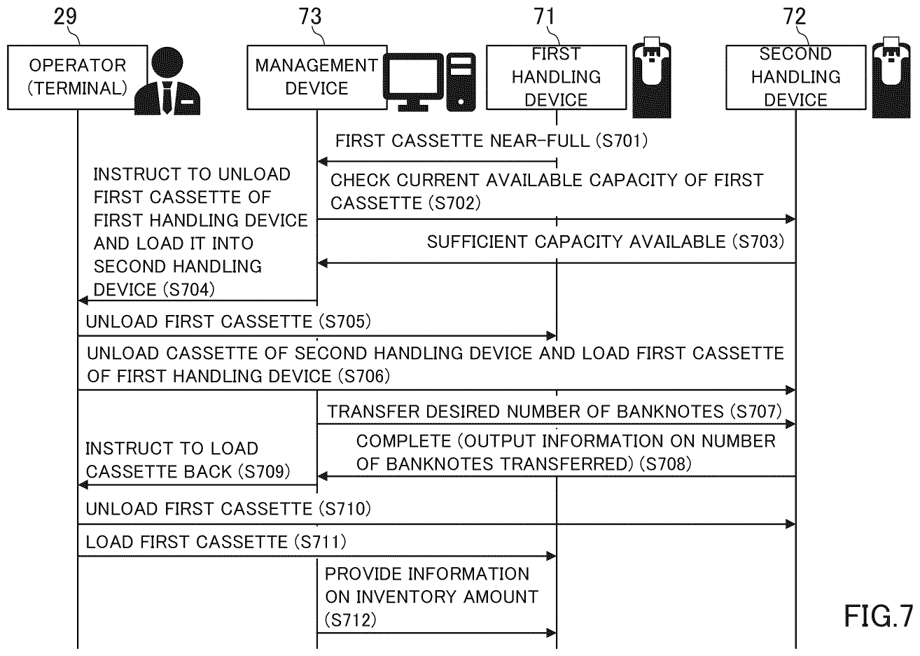

Next, a process of transferring money between the first handling device 71 and the second handling device 72 will be described with reference to FIGS. 6 and 7. FIG. 6 illustrates transfer of a cassette and transfer of money between the first handling device 71 and the second handling device 72 when any cassette has become near-full. FIG. 7 illustrates how information is transferred among the first handling device 71, the second handling device 72, the management device 73, and the terminal 29 in the money handling system 100 of FIG. 3.

First, step S601 of FIG. 6 shows that the first cassette 31 of the first handling device 71 has become near-full. The first cassette 31 is a cassette for storing one-dollar banknotes. The controller 15 of the first handling device 71 can determine that the first cassette 31 has become near-full by managing the inventory amounts of the cassettes 31 to 35 held in the memory unit 27. In step S701 of FIG. 7, the first handling device 71 sends information that the first cassette 31 has become near-full to the management device 72.

The terminal 29 connected to the first handling device 71 may determine that the first cassette 31 has become near-full by holding and managing the inventory amounts of the cassettes 31 to 35. In this case, the terminal 29 may send the information to the management device 73. Alternatively, the management device 73 may determine that the first cassette 31 of the first handling device 71 has become near-full by constantly holding and managing the inventory amounts of the cassettes 31 to 35 of the first handling device 71 and the inventory amounts of the cassettes 31 to 35 of the second handling device 72.

After it is determined that the first cassette 31 of the first handling device 71 has become near-full, the management device 73 checks the current available capacity of the first cassette 31 of the second handling device 72 that stores one-dollar banknotes (step S702). For example, as illustrated in FIG. 6, when the first cassette 31 of the second handling device 72 has sufficient available capacity, the second handling device 72 sends information that the first cassette 31 has sufficient available capacity to the management device 73 (step S703). That is, in steps S702 and S703, the management device 73 checks whether it is possible to transfer one-dollar banknotes from the first handling device 71 to the second handling device 72, more specifically, whether any cassette in the money handling system 100 is currently available for the transfer of one-dollar banknotes.

When it is possible to transfer one-dollar banknotes from the first handling device 71 to the second handling device 72, the money handling system 100 switches to the money transfer mode. The management device 73 notifies the operator that money is going to be transferred. Specifically, the management device 73 sends a notification to the operator via the terminal 29, prompting the operator to unload the first cassette 31 of the first handling device 71 from the first handling device 71 and load the unloaded first cassette 31 into the second handling device 72 (step S704). When the operator carries a mobile terminal, the management device 73 may send this notification to the operator via the mobile terminal.

In response to the notification, the operator unloads the first cassette 31 from the first handling device 71 (step S705). The operator also unloads a cassette other than the first cassette 31 from the second handling device 72 and loads the first cassette 31 of the first handling device 71 to the loading portion from which the cassette has been unloaded (step S706). In the example of FIG. 6, in step S602, the fifth cassette 35 for storing banknotes rejected in a withdrawal process is unloaded from the second handling device 72, and the first cassette 31 of the first handling device 71 is loaded into the second handling device 72. As described above, all the first to fifth cassettes 31 to 35 of the first handling device 71 and the second handling device 72 have the same shape and the same structure and can be loaded to any of the first to fifth loading portions 141 to 145. In the money transfer mode, the second handling device 72 allows any of the cassettes of the first handling device 71 to be loaded into any of the loading portions.

After the first cassette 31 of the first handling device 71 is loaded into the second handling device 72, the management device 73 instructs the second handling device 72 to transfer one-dollar banknotes from the first cassette 31 of the first handling device 71 to the first cassette 31 of the second handling device 72 (step S707 in FIG. 7).

As shown in step S603 of FIG. 6, the second handling device 72 transfers banknotes. More specifically, the transport unit 4 of the second handling device 72 transports the banknotes fed out of the first cassette 31 of the first handling device 71 to the recognition unit 25. After the recognition unit 25 recognizes and counts these banknotes, the transport unit 4 of the second handling device 72 transports them to the first cassette 31 of the second handling device 72. The first cassette 31 of the second handling device 72 thus stores the banknotes. The recognition unit 25 also reads the identification numbers of the banknotes.

The second handling device 72 can set the number of banknotes to be transferred to any value. However, the number of banknotes to be transferred is set within the range that satisfies the following two conditions: (1) the first cassette 31 of the first handling device 71 is no longer near-full and does not become near-empty, and (2) the first cassette 31 of the second handling device 72 does not become near-full. As an example, the second handling device 72 may transfer banknotes from the first cassette 31 of the first handling device 71 to the first cassette 31 of the second handling device 72 so that the first cassette 31 of the first handling device 71 and the first cassette 31 of the second handling device 72 have the same or substantially the same inventory amount. Alternatively, the second handling device 72 may transfer banknotes from the first cassette 31 of the first handling device 71 to the first cassette 31 of the second handling device 72 so that, for example, the inventory amount of the first cassette 31 of the first handling device 71 becomes half the inventory amount of the first cassette 31 of the first handling device 71 before the transfer. The second handling device 72 acquires the inventory amount of the first cassette 31 of the first handling device 71 before transferring money.

When the transfer of banknotes is completed, the second handling device 72 sends to the management device 73 information that the transfer is completed and information on how many banknotes have been transferred (step S708 in FIG. 7). The second handling device 72 may send the inventory amount of the first cassette 31 of the first handling device 71 and the inventory amount of the first cassette 31 of the second handling device 72 to the management device 73.

The management device 73 sends a notification to the operator via the terminal 29, prompting the operator to unload the cassette of the first handling device 71 from the second handling device 72 and loads it back into the first handling device 71 (step S709).

In response to the notification, the operator unloads the first cassette 31 of the first handling device 71 from the second handling device 72 and loads the fifth cassette 35 that has been unloaded from the second handling device 72 back into the fifth loading portion 145 of the second handling device 72 (step S710). The operator also loads the first cassette 31 of the first handling device 71 back into the first loading portion 141 of the first handling device 71 (step S711, step S604 in FIG. 6).

After the first cassette 31 is loaded into the first handling device 71, the management device 73 sends the inventory amount of the first cassette 31 to the first handling device 71 based on the information provided from the second handling device 52 (step S712). The controller 15 of the first handling device 71 updates the inventory amount of the first cassette 31.

Since money is transferred between the plurality of handling devices using a cassette, the operator does not have to handle money directly by hand. Therefore, an operator with no special authority can transfer money.

In the money transfer mode in which transfer of money is performed, the second handling device 72 allows a cassette unloaded from the first handling device 71 to be loaded into any of the first to fifth loading portions 141 to 145. As described above, each of the cassettes 31 to 35 has identification information. When the cassettes 31 to 35 are loaded to the loading portions 141 to 145, the handling device 1 reads the recognition information of the cassettes 31 to 35. When the predetermined condition is not satisfied at the time the cassettes 31 to 35 of the first handling device 71 are loaded to the loading portions 141 to 145, that is, when the condition that any cassette has become near-full is not satisfied at the time the cassettes 31 to 35 of the first handling device 71 are loaded to the loading portions 141 to 145, in other words, when not in the money transfer mode, the second handling device 72 does not allow any cassette unloaded from the first handling device 71 to be loaded to any of the loading portions 141 to 145. That is, the second handling device 72 will not operate even if any cassette unloaded from the first handling device 71 is loaded to any of the loading portions 141 to 145. The second handling device 71 may be configured to notify when a wrong cassette is loaded on any of the loading portions 141 to 145.

On the other hand, when the predetermined condition is satisfied, that is, when the condition that any cassette has become near-full is satisfied, in other words, when in the money transfer mode, the second handling device 72 allows any of the cassettes 31 to 35 of the first handling device 71 to be loaded into any of the first to fifth loading portions 141 to 145. That is, the second handling device 72 performs the transfer of money after any cassette unloaded from the first handling device 71 is loaded to any of the loading portions 141 to 145. Alternatively, the second handling device 72 may perform the transfer of money only when a cassette for the money transfer mode is loaded to any of the loading portions 141 to 145. In the example shown in FIG. 6, the cassette for the money transfer mode is the first cassette 31 of the first handling device 71. The second handling device 71 may perform the transfer of money only when the identification information of the cassette loaded to any of the loading portions 141 to 145 of the second handling device 71 is the first cassette 31 of the first handling device 71.

The second handling device 72 transfers banknotes between the loaded cassette and another cassette. The money handling system 10 or 100 can thus implement transfer of money between the plurality of handling devices in a simple manner. The second handling device 72 also updates the inventory amount of the cassette based on the stored amount of money that has changed as a result of the transfer of banknotes. After the update, the second handling device 72 may perform normal money handling such as a deposit process and/or a withdrawal process.

The first handling device 71 allows a cassette that has been unloaded from the first handling device 71 and whose inventory amount has changed to be loaded back into the first handling device 71. After updating the inventory amount of this cassette, the first handling device 71 may perform normal money handling such as a deposit process and/or a withdrawal process.

It should be understood that the same process can be performed even when the first handling device 71 and the second handling device 72 are switched around. That is, when any cassette in the second handling device 72 has become near-full, this cassette may be unloaded from the second handling device 72 and loaded to the first handling device 71 to execute the money transfer mode.

Money Transfer Process when any Cassette has Become Near-Empty

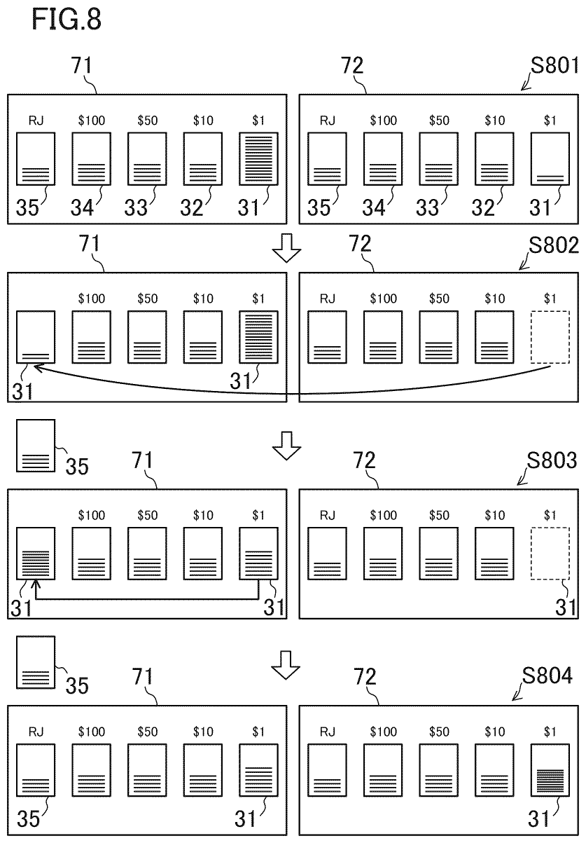

Next, a process of transferring money between the first handling device 71 and the second handling device 72 when any cassette has become near-empty in the second handling device 72 will be described with reference to FIG. 8.

First, step S801 of FIG. 8 illustrates that the first cassette 31 of the second handling device 72 has become near-empty. The first cassette 31 is a cassette for storing one-dollar banknotes.

After it is determined that the first cassette 31 has become near-empty, the management device 73 checks the inventory amount of the cassette of the first handling device 71 that stores one-dollar banknotes. That is, the management device 73 checks whether it is possible to transfer one-dollar banknotes from the first handling device 71 to the second handling device 72, more specifically, whether any cassette in the money handling system 100 is currently available for the transfer of one-dollar banknotes. In the example of FIG. 8, the first cassette 31 of the first handling device 71 stores a sufficient number of one-dollar banknotes. Therefore, the first handling device 71 has a cassette from which one-dollar banknotes can be transferred to the second handling device 72.

In response to a notification received from the management device 73 via the terminal 29, the operator unloads the first cassette 31 of the second handling device 72. The operator also loads the unloaded first cassette 31 to any of the loading portions of the first handling device 71 (except the first loading portion 141 with the first cassette 31 loaded therein). In the example of FIG. 8, the fifth cassette 35 of the first handling device 71 is unloaded, and the first cassette 31 of the second handling device 72 is loaded into the first handling device 71 (step S802).

After the first cassette 31 of the second handling device 72 is loaded, the first handling device 71 transfers banknotes from the first cassette 31 of the first handling device 71 to the first cassette 31 of the second handling device 72 (step S803). More specifically, the transport unit 4 of the first handling device 71 transports banknotes fed out of the first cassette 31 of the first handling device 71 to the recognition unit 25. After the recognition unit 25 recognizes and counts these banknotes, the transport unit 4 of the first handling device 71 transports them to the first cassette 31 of the second handling device 72. The first cassette 31 of the second handling device 72 thus stores the banknotes. The recognition unit 25 also reads the identification numbers of the banknotes.

In this case as well, the first handling device 71 can set the number of banknotes to be transferred to any value. However, the number of banknotes to be transferred is set within the range that satisfies the following two conditions: (1) the first cassette 31 of the second handling device 72 is no longer near-empty and does not become near-full, and (2) the first cassette 31 of the first handling device 71 does not become near-empty. As an example, the first handling device 71 may transfer banknotes from the first cassette 31 of the first handling device 71 to the first cassette 31 of the second handling device 72 so that the first cassette 31 of the first handling device 71 and the first cassette 31 of the second handling device 72 have the same or substantially the same inventory amount. Alternatively, the first handling device 71 may transfer banknotes from the first cassette 31 of the first handling device 71 to the first cassette 31 of the second handling device 72 so that, for example, the inventory amount of the first cassette 31 of the first handling device 71 becomes half the inventory amount of the first cassette 31 of the first handling device 71 before the transfer.

When the transfer of banknotes is completed, the management device 73 notifies the operator via the terminal 29. In response to the notification, the operator unloads the first cassette 31 of the second handling device 72 from the first handling device 71 and loads this first cassette 31 back into the second handling device 72. The operator also loads the fifth cassette 35 that has been unloaded from the first handling device 71 back into the first handling device 71 (step S804).

The transfer of money from the first handling device 71 to the second handling device 72 when any cassette has become near-empty is thus completed. Each of the first handling device 71 and the second handling device 72 updates the inventory amount of a corresponding one of the first cassettes 31.

As described above, money is transferred between the plurality of handling devices using a cassette, the operator does not have to handle money directly by hand. Therefore, an operator with no special authority can transfer money. Transfer of money between the plurality of handling devices is thus implemented in a simple manner.

There are cases where a branch of a financial institution uses cash-in-transit company (CIT) to collect money from the first handling device 71 and the second handling device 72 and/or replenish the first handling device 71 and the second handling device 72 with money. As described above, since the operator transfers money between the plurality of handling devices, the frequency at which any cassette becomes empty or full is reduced in each of the plurality of handling devices. This can reduce the frequency at which a person in charge of the CIT can perform collection of money and replenishment with money.

Process when any Banknote is Rejected During Transfer of Banknotes

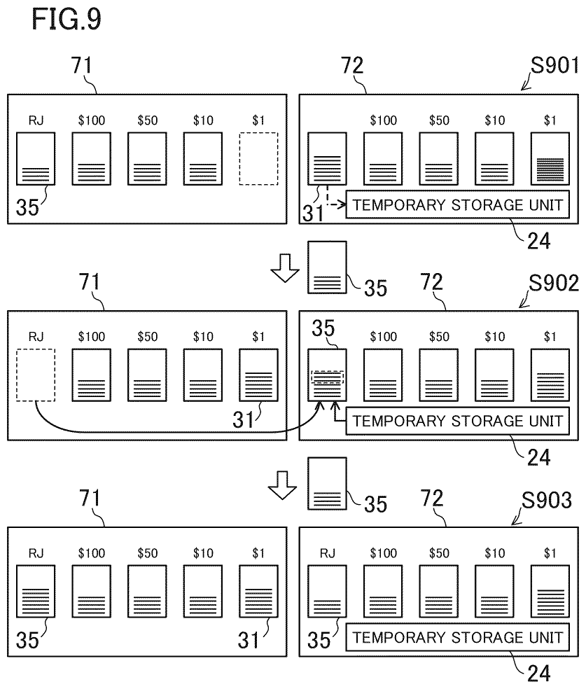

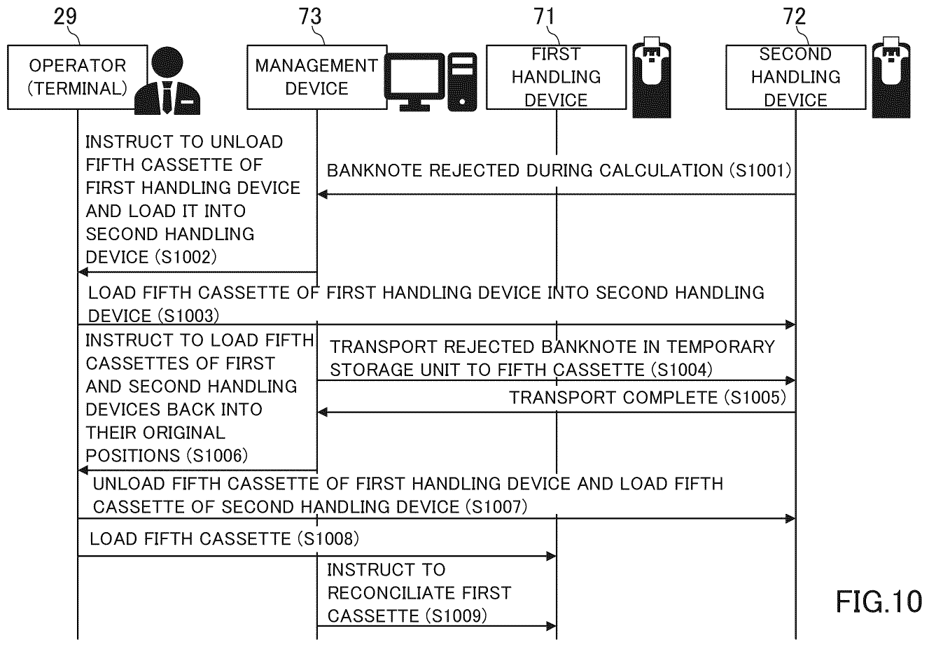

There are cases where a banknote is rejected while the second handling device 72 is transferring banknotes from a cassette of the first handling device 71 to a cassette of the second handling device 72 in, for example, step S603 of FIG. 6. FIGS. 9 and 10 illustrate a process when any banknote is rejected.

Step S901 of FIG. 9 shows where a rejected banknote is to be transported. When the recognition unit 25 determines a banknote to be a rejected banknote, the second handling device 72 stores this banknote in the temporary storage unit 24. The temporary storage unit 24 stores the rejected banknote until transfer of banknotes is completed in step S604 of FIG. 6. When any banknote is rejected, the second handling device 72 sends to the management device 73 information indicating that a banknote has been rejected, as shown in step S1001 of FIG. 10.

After the transfer of banknotes is completed and the first cassette 31 of the first handling device 71 is unloaded from the second handling device 72, the management device 73 sends a notification to the operator via the terminal 29, prompting the operator to unload the cassette of the first handling device 71 for storing banknotes rejected in a withdrawal process (in the illustrated example, the fifth cassette 35) from the first handling device 71 and load this cassette to any of the loading portions of the second handling device 72 (step S1002). In response to this notification, the operator unloads the fifth cassette 35 from the first handling device 71 and loads it into the second handling device 72 (step S1003). In the example of FIG. 9, the operator loads the fifth cassette 35 of the first handling device 71 to the loading portion of the second handling device 72 from which the fifth cassette 35 of the second handling device 72 has been unloaded (step S902).

After the fifth cassette 35 of the first handling device 71 is loaded into the second handling device 72, the management device 73 instructs the second handling device 72 to feed out the rejected banknote stored in the temporary storage unit 24 and store it in the fifth cassette of the first handling device 71 (step S1004). The second handling device 72 transports the rejected banknote from the temporary storage unit 24 to the fifth cassette 35 of the first handling device 71 according to the instruction (step S902 in FIG. 9). When the transfer of the rejected banknote is completed, the second handling device 72 notifies the management device 73 of the completion of the transfer of the rejected banknote (step S1005). The fifth cassette 35 of the first handling device 71 operates as a reject storage unit.

In response to the notification, the management device 73 instructs the operator via the terminal 29 to load the fifth cassette 35 of the first handling device 71 and the fifth cassette of the second handling device 72 back to their original loading portions (step S1006).

According to the instruction, the operator unloads the fifth cassette 35 of the first handling device 71 from the second handling device 72 and loads the fifth cassette 35 of the second handling device 72 into the second handling device 72 (step S1007), and loads the fifth cassette 35 of the first handling device 71 back into the first handling device 71 (step S1008).

After the fifth cassette 35 is loaded back into the first handling device 71 (step S903 in FIG. 9), the management device 73 instructs the first handling device 71 to perform a reconciliation process on the first cassette 31 that had the rejected banknote (step S1009). This is because the inventory amount of the first cassette 31 becomes uncertain due to the rejected banknote.

In response to the instruction from the management device 73, the first handling device 71 performs the reconciliation process on the first cassette 31. In the reconciliation process, the first handling device 71 may feed out all the banknotes stored in the first cassette 31 and may store the banknotes back into the first cassette 31 after the recognition unit 25 recognizes each of the banknotes. This corresponds to a full reconciliation process.

The first handling device 71 may perform a partial reconciliation process using the identification number list of the banknotes stored in the first cassette 31. In the partial reconciliation processing, the first handling device 71 fees out only part of the banknotes stored in the first cassette 31 from the first cassette 31, the recognition unit 25 read the identification numbers of the banknotes thus fed out of the first cassette 31 of the first handling device 71, and the first handling device 71 matches the identification numbers thus read by the recognition unit 25 against the identification numbers in the identification number list. The identification numbers of the banknotes fed out of the first cassette 31 are thus identified on the identification number list. In the identification number list, the identification numbers are arranged in the order in which the banknotes are stored. If the banknotes fed out of the first cassette 31 can be identified on the identification number list, the banknotes that has not yet been fed out of the first cassette 31 and thus are still stored in the first cassette 31 can also be identified on the identification number list. That is, the banknotes stored in the first cassette 31 are identified. The partial reconciliation process is a process in which the banknotes stored in a cassette can be identified by merely feeding out part of the banknotes stored in the cassette. The partial reconciliation process is advantageous in that the load of the reconciliation process is reduced and the time required for the process is significantly reduced compared to the full reconciliation process.

After any banknote is rejected while banknotes are being transferred in the second handling device 72, this rejected banknote is transferred from the second handling device 72 to the first handling device 71 using the fifth cassette 35 of the first handling device 71. The first handling device 71 then performs the reconciliation process on the first cassette 31. Through the reconciliation process, the inventory amount (IA3) of the first cassette 31 of the first handling device 71 after the transfer of the banknotes is confirmed. The number of banknotes (IA2) stored in the first cassette 31 of the second handling device 72 can also be confirmed in the second handling device 72. The inventory amount (IA1) of the first cassette 31 of the first handling device 71 is confirmed before the transfer of the banknotes is performed. Therefore, the number of banknotes rejected during the transfer of the banknotes can be confirmed by subtracting IA2 and IA3 from IA1 (IA1-IA2-IA3). That is, the inventory amount of the fifth cassette 35 for storing banknotes rejected in a withdrawal process can be confirmed.

If any banknote is rejected while the first handling device 71 is performing the reconciliation process on the first cassette 31, this rejected banknote is stored in the fifth cassette 35. All the banknotes rejected during the period from when the first cassette 31 is unloaded from the first handling device 71 until the inventory amount of the first cassette 31 loaded back into the first handling device 71 is confirmed by the reconciliation process are stored in the fifth cassette 35 of the first handling device 71. Therefore, even if any banknote is rejected during the reconciliation process on the first cassette 31, the first handling device 71 can confirm the inventory amount of the fifth cassette 35.

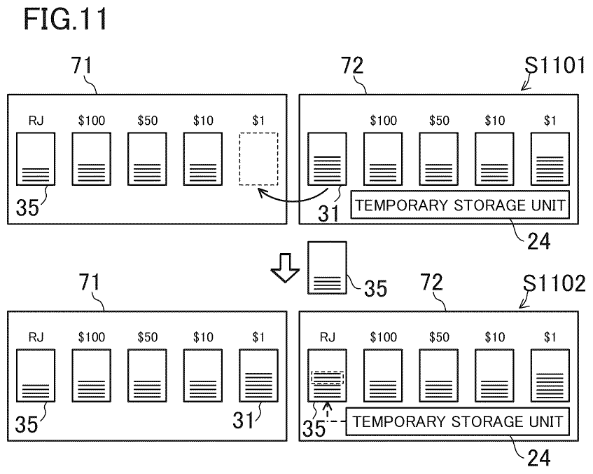

First Modification FIG. 11 shows a variation of a process when any banknote is rejected while banknotes are being transferred in the second handling device 72. Step S1101 of FIG. 11 is a step in which, after transfer of banknotes from the first cassette 31 of the first handling device 71 to the first cassette 31 of the second handling device 72 is completed, the operator unloads the first cassette 31 of the first handling device 71 from the second handling device 72 and loads the unloaded first cassette 31 back into the first handling device 71. A banknote has been rejected during the transfer of banknotes, and this rejected banknote is stored in the temporary storage unit 24 of the second handling device 72.

In the following step S1102, the operator loads the fifth cassette 35 of the second handling device 72 that has been unloaded from the second handling device 72, namely the cassette for storing banknotes rejected during a withdrawal process, back into the second handling device 72. Thereafter, the temporary storage unit 24 of the second handling device 72 feeds out the banknote rejected during the transfer of banknotes, and the fifth cassette 35 stores this rejected banknote. Although not shown in FIG. 11, the first handling device 71 performs the reconciliation process on the first cassette 31 to confirm the inventory amount of the first cassette 31.

In this case, part of the banknotes originally stored in the first handling device 71 is stored as rejected banknotes in the fifth cassette 35 of the second handling device 72 for storing rejected banknotes. The fifth cassette 35 of the second handling device 72 operates as a reject storage unit in this case.

In the case where the inventory amount of the first cassette 31 of the first handling device 71 is confirmed with no banknote being rejected while the first handling device 71 is performing the reconciliation process on the first cassette 31 of the first handling device 71, the number of rejected banknotes stored in the fifth cassette 35 of the second handling device 72 can be confirmed. The second handling device 72 may update the inventory amount of the fifth cassette 35 according to the results of the reconciliation process on the first handling device 71.

When any banknote is rejected while the first handling device 71 is performing the reconciliation process on the first cassette 31, this rejected banknote is stored in the fifth cassette of the first handling device 71. In this case, any banknotes rejected during the period from when the first cassette 31 is unloaded from the first handling device 71 until the inventory amount of the first cassette 31 loaded back into the first handling device 71 is confirmed by the reconciliation process are stored in the fifth cassette 35 of the first handling device 71 and the fifth cassette 35 of the second handling device 72. Therefore, the inventory amount of the rejected banknotes can be confirmed only by summing up the number of rejected banknotes in the fifth cassette 35 of the first handling device 71 and the number of rejected banknotes in the fifth cassette 35 of the second handling device 72.

The management device 73 and/or each handling device 71, 72 adds the inventory amount of the fifth cassette 35 of the first handling device 71 and the inventory amount of the fifth cassette 35 of the second handling device 72, and holds and manages the total inventory amount.

Second Modification

The reconciliation process that is performed on the first cassette 31 of the first handling device 71 after step S903 of FIG. 9 may be omitted. In this case, the inventory amount of the first cassette 31 is not confirmed, but any banknote rejected during transfer of banknotes in the second handling device 72 is transferred from the second handling device 72 to the first handling device 71 by using the fifth cassette 35. The number of banknotes transferred to the first cassette 31 of the second handling device 72 can also be confirmed. Therefore, the total inventory amount of the first handling device 71, namely the sum of the inventory amounts of the first and fifth cassettes 31, 35, can be confirmed.

Third Modification

The reconciliation process that is performed on the first cassette 31 of the first handling device 71 after step S1102 of FIG. 11 may be omitted. In this case, the inventory amount of the first cassette 31 of the first handling device 71 is not confirmed, and any banknote rejected during transfer of banknotes in the second handling device 72 is stored in the fifth cassette 35 of the second handling device 72. Therefore, the sum of the total inventory amount of the first handling device 71 and the total inventory amount of the second handling device 72 can be confirmed.

### Other Embodiments

Although FIGS. 7 and 10 illustrate examples of the process related to transfer of money in the money handling system 100 including the management device 73, the process related to transfer of money can be performed in the money handling system 10 that does not include the management device 73. In this case, the process that is performed by the management device 73 can be performed by the first handling device 71 or the second handling device 72.

For example, the handling device serving also as the management device 73 may be set in advance from the plurality of handling devices included in the money handling system 10.

For example, when any cassette has become near-empty or near-full, the handling device with the near-empty or near-full cassette may serve as the management device 73. In this case, the handling device with the near-empty or near-full cassette may check whether any cassette that can transfer money is present in any of the other handling devices. Alternatively, either a flag may be set for the handling device with a near-empty or near-full cassette or a notification may be sent to the other handling devices to check whether any cassette that can transfer money is present in any of the other handling devices.

Although the money handling system described above includes two handling devices, namely the first handling device 71 and the second handling device 72, the money handling system may include three or more handling devices. In this case, the handling device that transfers money to or from the handling device with a near-empty or near-full cassette can be determined according to various conditions. For example, when any of the cassettes has become near-empty, the handling device having the largest inventory amount of money available to be transferred to this cassette may be selected as a handling device that performs transfer of money. Similarly, when any cassette has become near-full, the handling device having the smallest inventory amount of money available to be transferred to this cassette may be selected as the handling device that performs transfer of money.

In the money handling system including three or more handling devices, the operator may transfer cassettes among the three or more handling devices to perform transfer of money.

In FIG. 6 or 8, the near-empty or near-full cassette is transferred to the other handling device. However, the cassette may be transferred the other way around. In other words, another cassette that performs transfer of money to and from the near-empty or near-full cassette may be transferred from the other handling device to the handling device.

In the above description, the condition to perform transfer of money is that any cassette has become near-full or near-empty, and the handling device determines that any cassette has become near-full or near-empty. Alternatively, the operator (e.g., a bank employee) may perform transfer of money at any desired time.

As described above, cash-in-transit (CIT) may be used to collect money from the first handling device 71 and the second handling device 72 and/or replenish the first handling device 71 and the second handling device 72 with money. In order to reduce the number of cassettes a person in charge of the CIT needs to collect, the operator may perform the above process of transferring money between the plurality of handling devices so that one of the cassette stores a large amount of money. In order to reduce the number of cassettes a person in charge of the CIT needs to replenish with money, the operator may perform the above process of transferring money between the plurality of handling devices so that one of the cassette stores a small amount of money. Such an operation reduces the number of cassettes the person in charge of the CIT needs to transfer and reduces the time during which the person in charge of the CIT needs to stay in a branch of a financial institution to perform the collection and replenishment process.

What is claimed is:

1. A money handling method that is performed by a first handling device including at least one first money storage and a second handling device including at least one second money storage, the first money storage configured to store money deposited from a first inlet and feed out stored money to be dispensed from a first outlet, and the second money storage configured to store money deposited from a second inlet and feed out stored money to be dispensed from a second outlet, the money handling method comprising:
sending, in a case where a predetermined condition is satisfied, a notification prompting to unload the second money storage from the second handling device and load the second money storage into the first handling device; and
causing the first handling device to transfer money between the second money storage loaded to the first handling device and the first money storage.

2. The money handling method of claim 1, wherein
the predetermined condition includes that an inventory amount of the first money storage is smaller than a first criterion or is larger than a second criterion.

3. The money handling method of claim 2, wherein
whether there is the second money storage that is able to transfer money to or from the first money storage is checked in a case where the inventory amount of the first money storage is smaller than the first criterion or larger than the second criterion.

4. The money handling method of claim 1, wherein
the predetermined condition includes that an inventory amount of the second money storage is smaller than a first criterion or is larger than a second criterion.

5. The money handling method of claim 4, wherein
whether there is the first money storage that is able to transfer money to or from the second money storage is checked when the inventory amount of the second money storage is smaller than the first criterion or larger than the second criterion.

6. The money handling method of claim 1, wherein
the inventory amount of the first money storage is updated after money is transferred between the second money storage and the first money storage.

7. The money handling method of claim 1, wherein
the first handling device is caused to output information on transfer of money between the second money storage and the first money storage,
after the transfer of money between the second money storage and the first money storage is completed, a notification is sent that prompts to load the second money storage unloaded from the first handling device back into the second handling device, and
the inventory amount of the second money storage is updated based on the information.

8. The money handling method of claim 1, wherein
in a case where any money is rejected while money is being transferred between the second money storage loaded to the first handling device and the first money storage, the second handling device is caused to perform a reconciliation process after the second money storage is loaded into the second handling device, the reconciliation process being a process of confirming the inventory amount of the second money storage.

9. The money handling method of claim 1, wherein
in a case where any money is rejected while money is being transferred between the second money storage loaded to the first handling device and the first money storage,
the rejected money is stored in a first reject storage of the first handling device.

10. The money handling method of claim 9, wherein
after the money is rejected, a sum of an inventory amount of the first reject storage of the first handling device and an inventory amount of a second reject storage of the second handling device is held as an inventory amount.

11. The money handling method of claim 1, wherein
in a case where any money is rejected while money is being transferred between the second money storage loaded to the first handling device and the first money storage,
the first handling device stores the rejected money in a temporary storage, and
after transfer of money between the second money storage and the first money storage is completed, the first handling device transfers the rejected money in the temporary storage to a second reject storage of the second handling device that has been loaded to the first handling device.

12. A money handling device, comprising:
at least one first money storage configured to store money deposited from an inlet and feed out stored money to be dispensed from an outlet;
a plurality of loading portions to which the first money storage is detachably loaded; and
a controller configured to perform a process related to money using the first money storage, wherein
in a case where a predetermined condition is satisfied, the controller performs transfer of money between a second money storage unloaded from a second money handling device based on the predetermined condition and loaded to the loading portion and the first money storage.

13. The money handling device of claim 12, wherein
the first money storage is detachably loaded to each of the plurality of loading portions, and
the controller allows the second money storage to be loaded to any one of the plurality of loading portions.

14. The money handling device of claim 12, wherein
the controller allows the second money storage to be unloaded from the first handling device in order to load the second money storage back into the second money handling device after the transfer of money between the second money storage and the first money storage is completed.

15. A money handling system, comprising:
a first handling device including at least one first money storage configured to store money deposited from a first inlet and feed out stored money to be dispensed from a first outlet; and
a second handling device including at least one second money storage configured to store money deposited from a second inlet and feed out stored money to be dispensed the money from a second outlet, wherein
in a case where a predetermined condition is satisfied, a notification is sent that prompts to unload the second money storage from the second handling device and load the second money storage into the first handling device, and
the first handling device is caused to transfer money between the second money storage loaded to the first handling device and the first money storage.

16. The money handling system of claim 15, further comprising:
a management device connected to each of the first handling device and the second handling device, wherein
the management device checks whether the second money storage that is able to transfer money to or from the first money storage is present in the second handling device.
